(19) United States
(12) Patent Application Publication
(10) Pub. No.: US 2026/0129595 A1
(43) Pub. Date: May 7, 2026

(54) SAMPLING FREQUENCY OFFSET CONFIGURATION

(71) Applicant: QUALCOMM Incorporated, San Diego, CA (US)

(72) Inventors: Kazuki TAKEDA, Minato-ku (JP); Yuchul KIM, San Diego, CA (US); Le LIU, San Jose, CA (US)

(21) Appl. No.: 19/364,972

(22) Filed: Oct. 21, 2025

Related U.S. Application Data
(60) Provisional application No. 63/716,505, filed on Nov. 5, 2024.

(51) Int. Cl. H04W 56/00; H04W 8/22

(52) U.S. Cl. CPC H04W 56/0015; H04W 8/22

(57) ABSTRACT

Various aspects of the present disclosure generally relate to wireless communication. In some aspects, an ambient Internet-of-Things (A-IoT) device may receive, from a reader device, a first message, wherein the first message includes a type indication associated with whether the first message is associated with a clock adjustment. The A-IoT device may selectively transmit, to the reader device, a second message based on whether the first message is associated with the clock adjustment. Numerous other aspects are described.

### CROSS-REFERENCE TO RELATED APPLICATION

This patent application claims priority to U.S. Provisional Patent Application No. 63/716,505, filed on Nov. 5, 2024, entitled “SAMPLING FREQUENCY OFFSET CONFIGURATION,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with sampling frequency offset configuration.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by an ambient Internet-of-Things (A-IoT) device. The method may include receiving, from a reader device, a first message, wherein the first message includes a type indication associated with whether the first message is associated with a clock calibration. The method may include selectively transmitting, to the reader device, a second message based on whether the first message is associated with the clock calibration.

Some aspects described herein relate to a method of wireless communication performed by a reader device. The method may include transmitting, to an A-IoT device, a first message, wherein the first message includes a type indication associated with whether the first message is associated with a clock calibration. The method may include selectively receiving, from the A-IoT device, a second message based on whether the first message is associated with the clock calibration.

Some aspects described herein relate to a non-transitory computer-readable medium that stores a set of instructions for wireless communication. The set of instructions, when executed by one or more processors of the A-IoT device, may cause the A-IoT device to receive, from a reader device, a first message, wherein the first message includes a type indication associated with whether the first message is associated with a clock calibration. The set of instructions, when executed by one or more processors of the A-IoT device, may cause the A-IoT device to selectively transmit, to the reader device, a second message based on whether the first message is associated with the clock calibration.

Some aspects described herein relate to a non-transitory computer-readable medium that stores a set of instructions for wireless communication by a reader device. The set of instructions, when executed by one or more processors of the reader device, may cause the reader device to transmit, to an A-IoT device, a first message, wherein the first message includes a type indication associated with whether the first message is associated with a clock calibration. The set of instructions, when executed by one or more processors of the reader device, may cause the reader device to selectively receive, from the A-IoT device, a second message based on whether the first message is associated with the clock calibration.

Some aspects described herein relate to a A-IoT device for wireless communication. The A-IoT device may include one or more memories and one or more processors coupled to the one or more memories. The one or more processors may be configured to receive, from a reader device, a first message, wherein the first message includes a type indication associated with whether the first message is associated with a clock calibration. The one or more processors may be configured to selectively transmit, to the reader device, a second message based on whether the first message is associated with the clock calibration.

Some aspects described herein relate to a reader device for wireless communication. The reader device may include one or more memories and one or more processors coupled to the one or more memories. The one or more processors may be configured to transmit, to an A-IoT device, a first message, wherein the first message includes a type indication associated with whether the first message is associated with a clock calibration. The one or more processors may be configured to selectively receive, from the A-IoT device, a second message based on whether the first message is associated with the clock calibration.

Some aspects described herein relate to an apparatus for wireless communication. The apparatus may include means for receiving, from a reader device, a first message, wherein the first message includes a type indication associated with whether the first message is associated with a clock calibration. The apparatus may include means for selectively transmitting, to the reader device, a second message based on whether the first message is associated with the clock calibration.

Some aspects described herein relate to an apparatus for wireless communication. The apparatus may include means for transmitting, to an A-IoT device, a first message, wherein the first message includes a type indication associated with whether the first message is associated with a clock calibration. The apparatus may include means for selectively receiving, from the A-IoT device, a second message based on whether the first message is associated with the clock calibration.

Some aspects described herein relate to a method of wireless communication performed by an A-IoT device. The method may include receiving, from a reader device, a first message, wherein the first message includes a type indication associated with whether the first message is associated with a clock adjustment. The method may include selectively transmitting, to the reader device, a second message based on whether the first message is associated with the clock adjustment.

Some aspects described herein relate to a method of wireless communication performed by a reader device. The method may include transmitting, to an A-IoT device, a first message, wherein the first message includes a type indication associated with whether the first message is associated with a clock adjustment. The method may include selectively receiving, from the A-IoT device, a second message based on whether the first message is associated with the clock adjustment.

Some aspects described herein relate to a non-transitory computer-readable medium that stores a set of instructions for wireless communication. The set of instructions, when executed by one or more processors of the A-IoT device, may cause the A-IoT device to receive, from a reader device, a first message, wherein the first message includes a type indication associated with whether the first message is associated with a clock adjustment. The set of instructions, when executed by one or more processors of the A-IoT device, may cause the A-IoT device to selectively transmit, to the reader device, a second message based on whether the first message is associated with the clock adjustment.

Some aspects described herein relate to a non-transitory computer-readable medium that stores a set of instructions for wireless communication by a reader device. The set of instructions, when executed by one or more processors of the reader device, may cause the reader device to transmit, to an A-IoT device, a first message, wherein the first message includes a type indication associated with whether the first message is associated with a clock adjustment. The set of instructions, when executed by one or more processors of the reader device, may cause the reader device to selectively receive, from the A-IoT device, a second message based on whether the first message is associated with the clock adjustment.

Some aspects described herein relate to a A-IoT device for wireless communication. The A-IoT device may include one or more memories and one or more processors coupled to the one or more memories. The one or more processors may be configured to receive, from a reader device, a first message, wherein the first message includes a type indication associated with whether the first message is associated with a clock adjustment. The one or more processors may be configured to selectively transmit, to the reader device, a second message based on whether the first message is associated with the clock adjustment.

Some aspects described herein relate to a reader device for wireless communication. The reader device may include one or more memories and one or more processors coupled to the one or more memories. The one or more processors may be configured to transmit, to an A-IoT device, a first message, wherein the first message includes a type indication associated with whether the first message is associated with a clock adjustment. The one or more processors may be configured to selectively receive, from the A-IoT device, a second message based on whether the first message is associated with the clock adjustment.

Some aspects described herein relate to an apparatus for wireless communication. The apparatus may include means for receiving, from a reader device, a first message, wherein the first message includes a type indication associated with whether the first message is associated with a clock adjustment. The apparatus may include means for selectively transmitting, to the reader device, a second message based on whether the first message is associated with the clock adjustment.

Some aspects described herein relate to an apparatus for wireless communication. The apparatus may include means for transmitting, to an A-IoT device, a first message, wherein the first message includes a type indication associated with whether the first message is associated with a clock adjustment. The apparatus may include means for selectively receiving, from the A-IoT device, a second message based on whether the first message is associated with the clock adjustment.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating examples associated with different types of A-IoT devices.

FIG. 4 is a diagram illustrating an example associated with backscatter communications.

FIG. 5 is a diagram illustrating an example of clock adjustment.

FIGS. 6A-6G are diagrams illustrating an example associated with sampling frequency offset configuration.

FIG. 7 is a diagram illustrating an example process performed, for example, at an A-IoT device or an apparatus of an A-IoT device.

FIG. 8 is a diagram illustrating an example process performed, for example, at a reader device or an apparatus of a reader device.

FIG. 9 is a diagram of an example apparatus for wireless communication.

FIG. 10 is a diagram of an example apparatus for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

An ambient Internet-of-Things (A-IoT) device may have a clock that is used for digital sampling. Different clocks may have different accuracy levels. For example, a clock that uses a crystal oscillator may have a relatively high accuracy level. However, different types of crystal oscillators or different crystals may have different accuracy levels. Moreover, other clocks, which may have lower accuracy levels, may use resistor-capacitor (RC) oscillators, micro-electro-mechanical system (MEMS) oscillators, inverter-ring oscillators, phase-locked loops, or integrated circuit (IC) timing circuits. When an A-IoT device uses a clock for digital sampling, inaccuracy in the clock's ability to track an ideal time may result in +/−10% clock frequency error, or more. To account for such sampling clock frequency error, a communication system may provide for a guard interval or band. However, the presence of the guard interval or band may degrade spectral efficiency, by reserving some frequency or time resources as unused. Additionally, or alternatively, a reader device, such as a user equipment (UE), may estimate or measure the sampling clock frequency error of the A-IoT device, which may increase a device complexity at the reader device. Performing an estimation or measurement of the sampling clock frequency error of the A-IoT device may increase overhead for device-to-reader (D2R) communication, such as by resulting in the introduction of excessive reference signals.

Various aspects relate generally to sampling frequency offset configuration. Some aspects more specifically relate to a reader-to-device (R2D) message associated with clock adjustment, which may include calibration, synchronization, or error correction. In some aspects, a reader device, such as a UE, may transmit a first message that includes a type indication that the message is associated with a clock adjustment. The A-IoT device may receive the first message, perform clock adjustment, and transmit a second message, as a response and using a calibrated clock, based on receiving the first message with the type indication. In some aspects, the type indication may be an explicit indicator (e.g., a bit indicator) or an implicit indication (e.g., an indication by selection of message format or response message resource allocation). In some aspects, the first message may include a dedicated adjustment portion for the A-IoT device, or the A-IoT device may be configured to use on-off keying (OOK) rising or falling edges for clock adjustment.

Particular aspects of the subject matter described in this disclosure can be implemented to realize one or more of the following potential advantages. In some examples, the described techniques can be used to maintain a high degree of clock synchronization in a network with A-IoT devices. By maintaining a high degree of clock synchronization, the network may omit guard periods or intervals (or use smaller guard periods or intervals), which improves spectral efficiency. In some examples, the described techniques can be used to reduce reader complexity or message overhead. For example, by maintaining clock synchronization, the reader may forgo using reference signals and clock estimation to compensate for a sampling frequency offset (e.g., between an ideal clock and an actual clock of the A-IoT device).

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

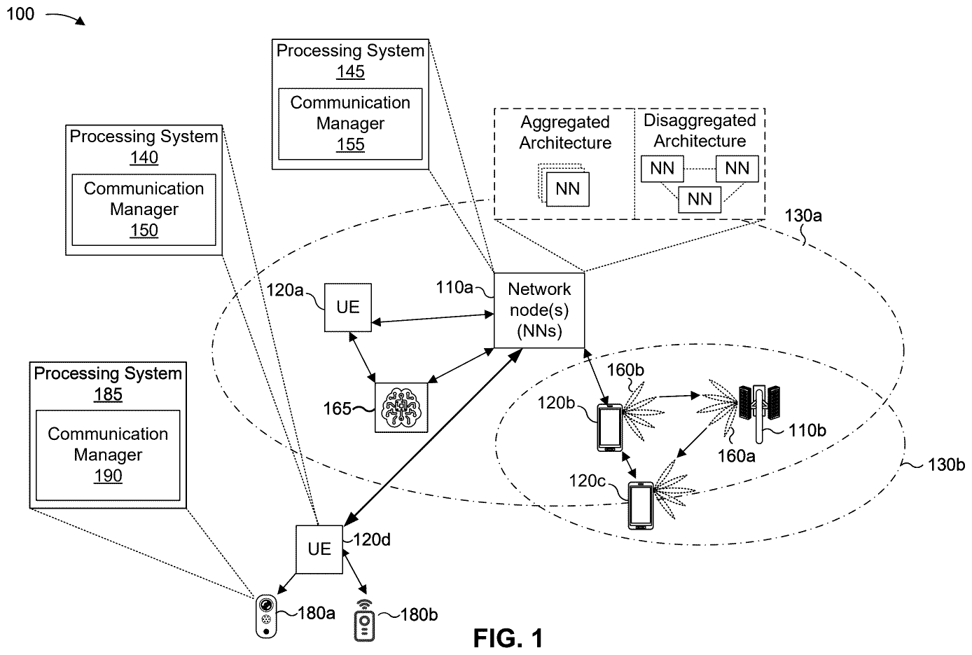

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, a UE 120c, a UE 120d. In some examples, a UE 120 may also communicate with other UEs 120 and a network node 110 may communicate with a core network and with other network nodes 110. In some examples, a UE 120 may communicate with an A-IoT device 180, such as an A-IoT device 180a or an A-IoT device 180b.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHZ), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140, the processing system 145, or the processing system 185 may each include or be coupled with one or more modems (such as a cellular (for example, a 5G or 6G compliant) modem). In some examples, one or more processors of the processing system 140, the processing system 145, the processing system 185 include or implement one or more of the modems. The processing system 140, the processing system 145, the processing system 185 may also include or be coupled with multiple radios (collectively “the radio”), multiple RF chains, or multiple transceivers, each of which may in turn be coupled with one or more of multiple antennas. In some examples, one or more processors of the processing system 140, the processing system 145, and/or the processing system 185 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120, by the processing system 145 of the network node 110, or by the processing system 185 of the A-IoT device 180).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

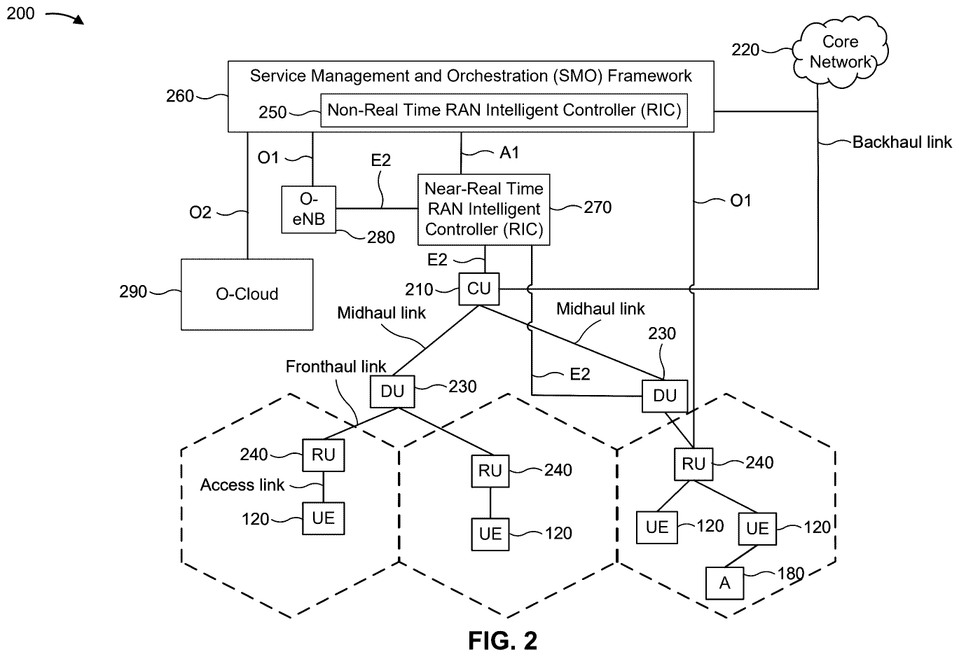

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples, UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples, CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110, the UE 120, or the A-IoT device 180 (for example, using the processing system 145, the processing system 140, or the processing system 185, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110, the UE 120, or the A-IoT device 180 (such as by using the processing system 145, the processing system 140, or the processing system 185, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110, the UE 120, or the A-IoT device 180 (for example, using the processing system 145, the processing system 140, or the processing system 185, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110, the UE 120, or the A-IoT device 180 (for example, using the processing system 145, the processing system 140, or the processing system 185, respectively, and/or one or more modems) may further perform spatial processing (for example, precoding) on the encoded information to generate one or more processed or precoded signals for downlink or uplink transmission, respectively. In some examples, the network node 110, the UE 120, or the A-IoT device 180 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110, the UE 120, or the A-IoT device 180 (for example, using the processing system 145, the processing system 140, or the processing system 185, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110, the UE 120, or the A-IoT device 180 (for example, using the processing system 145, the processing system 140, or the processing system 185, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples. MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), an A-IoT device 180 (for example, the processing system 185), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Some IoT devices, such as A-IoT devices, such as the A-IoT devices 180, (sometimes referred to as ultra-light IoT devices), may be associated with a relatively simple hardware design that may be designed to use low power and be implementable at low cost. A-IoT technology may include passive IoT (such as NR passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling.

To achieve further cost reduction and zero-power communication, backscattering communication may be implemented at a type of passive IoT device referred to as an “ambient backscatter device” or a “backscatter device,” which may modulate a reflecting radio signal from an RF source to convey data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices.

An active IoT device may have a battery or similar energy source and an active radio, allowing for active transmission and reception without energy harvesting or backscattering. A-IoT technology may be useful in connection with industrial sensors, for which battery replacement may be prohibitively difficult or undesirable (such as for safety monitoring or fault detection in smart factories, infrastructures, or environments). Additionally, features of A-IoT devices, such as low cost, small size, simple or infrequent maintenance, durability, and long lifespan, may facilitate smart logistics and warehousing (for example, in connection with automated asset management). Furthermore, A-IoT technology may be useful in connection with smart home networks for household item management, wearable devices, or similar applications.

In some A-IoT deployments, a reader device, such as a UE 120d, may communicate with one or more A-IoT devices, such as A-IoT devices 180a and 180b. For example, the reader device may transmit a reader-to-device (R2D) message to the A-IoT devices and may receive a device-to-reader (D2R) message from an A-IoT device. The R2D message may include a physical R2D channel (PRDCH) that conveys information for the A-IoT devices. The D2R message may include a physical D2R channel (PDRCH) that conveys response information from an A-IoT device. In some examples, an A-IoT device 180 may include a processing system 185, as described in more detail herein. In some examples, the processing system 185 and/or a communication manager 190 may have reduced capabilities relative to, for example, the processing system 140 and/or the communication manager 150, respectively, as described in more detail herein.

In some aspects, the A-IoT device 180 may include a communication manager 190. As described in more detail elsewhere herein, the communication manager 190 may receive, from a reader device, a first message, wherein the first message includes a type indication associated with whether the first message is associated with a clock adjustment; and selectively transmit, to the reader device, a second message based on whether the first message is associated with the clock adjustment. Additionally, or alternatively, the communication manager 190 may perform one or more other operations described herein.

In some aspects, a reader device, such as a UE 120, may include a communication manager 150. As described in more detail elsewhere herein, the communication manager 150 may transmit, to an A-IoT device, a first message, wherein the first message includes a type indication associated with whether the first message is associated with a clock adjustment; and selectively receive, from the A-IoT device, a second message based on whether the first message is associated with the clock adjustment. Additionally, or alternatively, the communication manager 150 may perform one or more other operations described herein. Although some aspects are described herein in terms of a UE 120 being a reader device, another device may be a reader device, such as the network node 110, which may include a communication manager 155 configured to perform one or more operations described herein.

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240. In some deployments a UE 120 may serve an A-IoT device 180.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO

Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-cNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-cNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

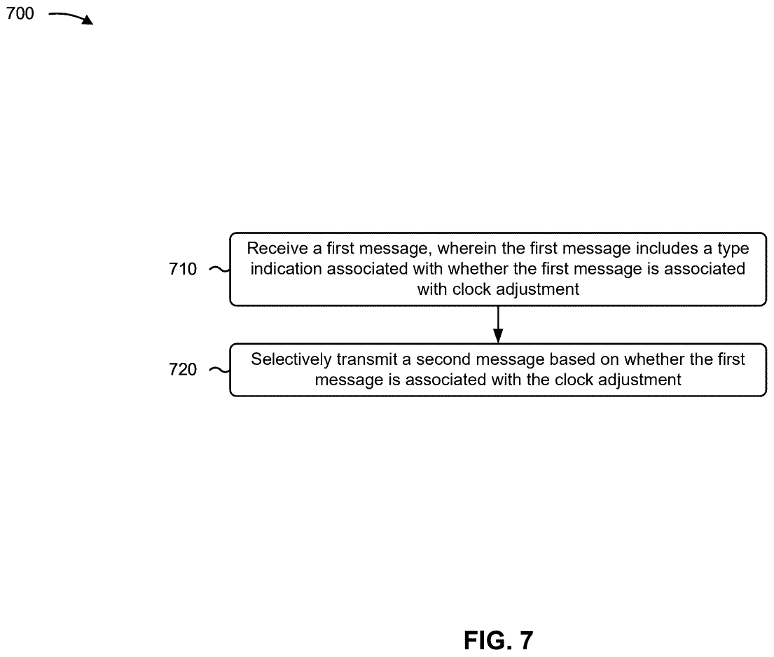

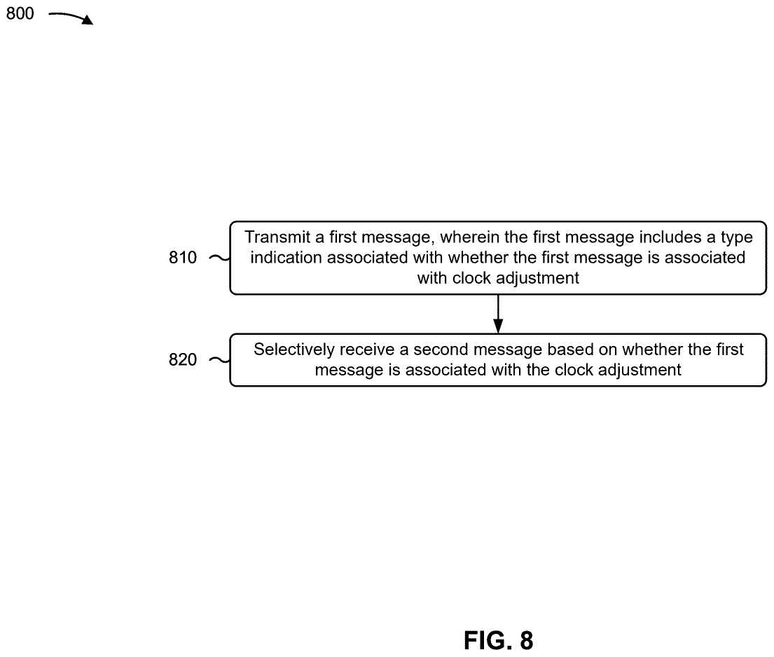

The A-IoT device 180, the processing system 185 of the A-IoT device 180, the UE 120, the processing system 140 of the UE 120, the CU 210, the DU 230, the RU 240, the network node 110, or any other component(s) of FIG. 1 and/or FIG. 2 may implement one or more techniques or perform one or more operations associated with sampling frequency offset configuration, as described in more detail elsewhere herein. For example, the processing system 185 of the A-IoT device 180, the processing system 140 of the UE 120, the network node 110, the CU 210, the DU 230, or the RU 240 may perform or direct operations of, for example, process 700 of FIG. 7, process 800 of FIG. 8, or other processes as described herein (alone or in conjunction with one or more other processors). Memory of the A-IoT device 180 may store data and program code (or instructions) for the A-IoT device 180. Memory of a UE 120 may store data and program code (or instructions) for the UE 120, such as context information. In some examples, the memory of the UE 120 or the memory of the A-IoT device 180 may include a non-transitory computer-readable medium storing a set of instructions for wireless communication. For example, the set of instructions, when executed by one or more processors (for example, of the processing system 185 or the processing system 140) of the network node 110, the UE 120, A-IoT device 180, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

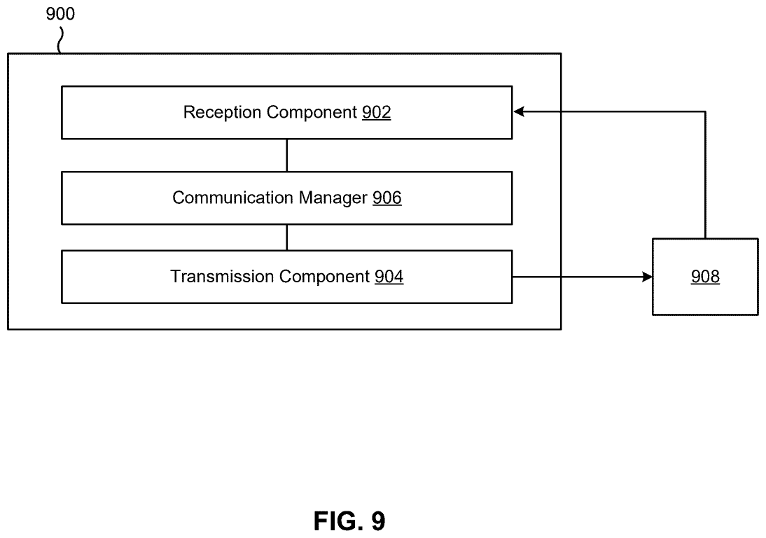

In some aspects, the A-IoT device 180 includes means for receiving, from a reader device, a first message, wherein the first message includes a type indication associated with whether the first message is associated with a clock adjustment; and/or means for selectively transmitting, to the reader device, a second message based on whether the first message is associated with the clock adjustment. In some aspects, the means for the A-IoT device 180 to perform operations described herein may include, for example, one or more of communication manager 190, processing system 185, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

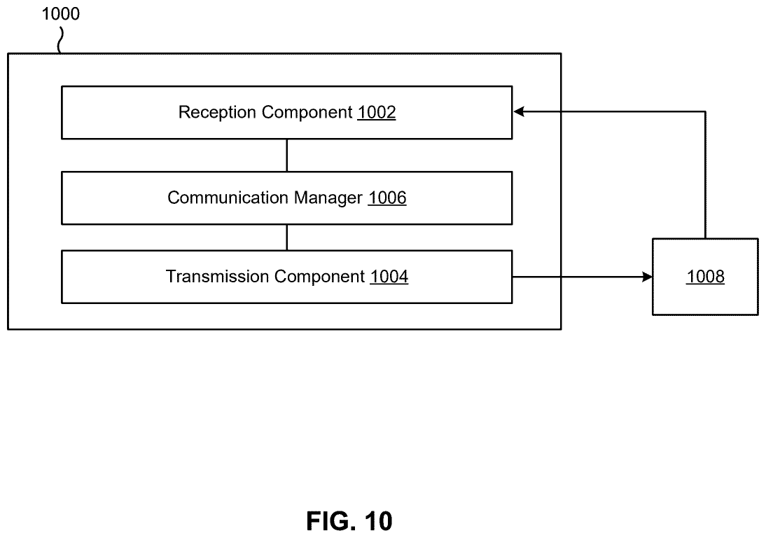

In some aspects, a reader device, such as the UE 120, includes means for transmitting, to an A-IoT device, a first message, wherein the first message includes a type indication associated with whether the first message is associated with a clock adjustment; and/or means for selectively receiving, from the A-IoT device, a second message based on whether the first message is associated with the clock adjustment. In some aspects, the means for the reader device (e.g., the UE 120) to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

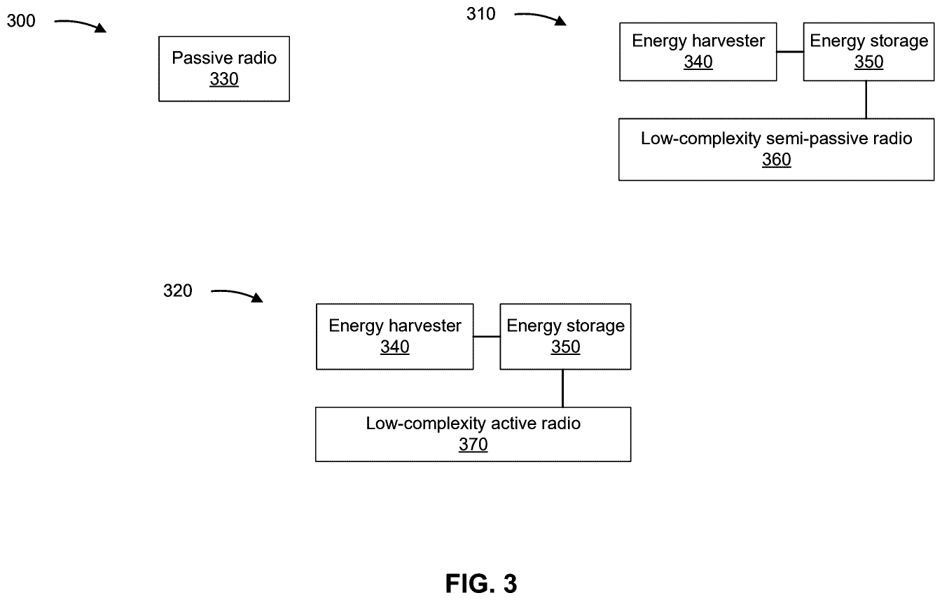

FIG. 3 is a diagram illustrating examples 300, 310, and 320 associated with different types of A-IoT devices.

Example 300 illustrates components of a passive A-IoT device. As shown, passive A-IoT devices may include a passive radio 330. For example, the passive radio 330 may be configured to backscatter a carrier wave (CW).

Example 310 illustrates components of a semi-passive A-IoT device. As shown, semi-passive A-IoT devices may include an energy harvester 340, an energy storage 350, and/or a low-complexity semi-passive radio 360. For example, the low-complexity semi-passive radio 360 may be configured to harvest energy from a CW using the energy harvester 340, store energy from a CW using the energy storage 350, and/or backscatter a CW.

Example 320 illustrates components of an active A-IoT device. As shown, active A-IoT devices may include an energy harvester 340, an energy storage 350, and/or a low-complexity (for example, low-cost) active radio 370. For example, the low-complexity active radio 370 may be configured to harvest energy from a CW using the energy harvester 340, store energy from a CW using the energy storage 350, and/or backscatter a CW.

A-IoT devices may be categorized into at least three types of devices: device 1, device 2a, and device 2b. Device 1 type A-IoT devices may include at least some passive and/or semi-passive devices. A device 1 type A-IoT device may have approximately 1 μW peak power consumption, support energy storage, use an initial sampling frequency offset (SFO) up to 10X ppm (for example, where X can be any suitable value), and communicate uplink transmissions by backscattering externally-provided CWs.

Device 2a type A-IoT devices may include at least some semi-passive devices, and device 2b type A-IoT devices may include active devices. Both device 2a and device 2b type A-IoT devices may have less than or equal to a few hundred μW peak power consumption, support energy storage, and use an initial SFO up to 10X ppm. A device 2a type A-IoT device may communicate uplink transmissions by backscattering externally-provided CWs. A device 2b type A-IoT device may communicate uplink transmissions by internally generating the uplink transmission.

In some examples, device 1, device 2a, and/or device 2b type A-IoT devices that are located indoors may support a maximum distance of 10-50 m, a range which may be sub-selected. In Topology 1 (for example, in which an A-IoT device may directly and bidirectionally communicate with one or more network nodes 110) and in Topology 2 (for example, in which an A-IoT device may communicate bidirectionally with an intermediate node between the A-IoT device and a network node 110), device 1, device 2a, and/or device 2b type A-IoT devices may not support RRC states, mobility (for example, cell-selection/re-selection-like functionality), automatic repeat request (ARQ), or hybrid ARQ (HARQ).

As indicated above, FIG. 3 is provided as an example. Other examples may differ from what is described with respect to FIG. 3.

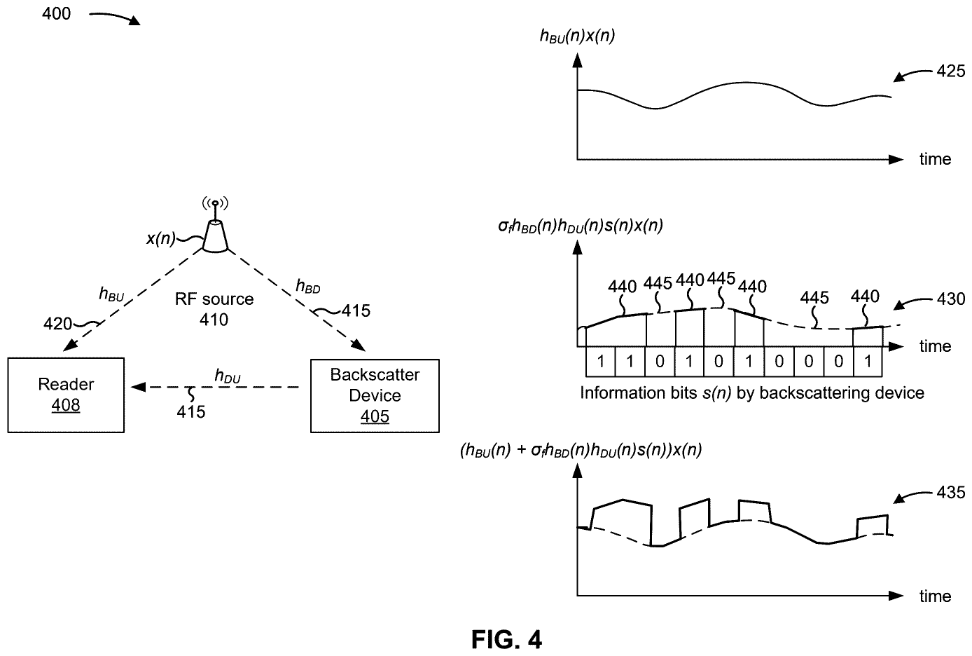

FIG. 4 is a diagram illustrating an example 400 associated with backscatter communications.

Some wireless communication devices may be considered IoT devices, such as A-IoT devices (sometimes referred to as ultra-light IoT devices), or similar IoT devices. In A-IoT, a terminal (for example, a radio frequency identification (RFID) device, a tag, or a similar device) may not include a battery, and the terminal may accumulate energy from radio signaling. To achieve further cost reduction and zero-power communication, wireless networks may utilize a type of A-IoT device referred to as an “ambient backscatter device” or a “backscatter device.”

As shown in FIG. 4, a backscatter device 405 (for example, a tag or a sensor, among other examples), which may be one example of an A-IoT device such as a passive, semi-passive, or active A-IoT device described with regard to FIG. 3, may employ a simplified hardware design (for example, including a power splitter, an energy harvester, and a microcontroller) that does not include a battery, such that the backscatter device 405 relies on energy harvesting for power, and that does not include a radio wave generation circuit, such that the backscatter device 405 is capable of transmitting information only by reflecting a radio wave. More particularly, the backscatter device 405 communicates with a reader 408 (for example, a UE 120, a network node 110, or another network device) by modulating a reflecting radio signal from an RF source 410 (for example, a network node 110, a UE 120, or another network device). In some examples, the RF source 410 and the reader 408 may be the same device and/or may be co-located. For example, in some instances, the reader 408 and the RF source 410 may be associated with the same network node 110.

To facilitate communication of the backscatter device 405, the RF source 410 may transmit an energy harvesting wave to the backscatter device 405. The energy harvesting wave may be transmitted for a sufficient duration in order to enable a communication phase for a target range between the reader 408 and the backscatter device 405. Additionally or alternatively, in some instances, a range between the RF source 410 and the backscatter device 405 may be limited by a minimum received power for triggering energy harvesting at the backscatter device 405, such as −20 decibel milliwatts (dBm).

Once energy is sufficiently accumulated at the backscatter device 405, the backscatter device 405 may begin to reflect the radio wave that is radiated onto the backscatter device 405 via a backscatter link 415. For example, the RF source 410 may initiate a communication session (sometimes referred to as a query-response communication) with a query, which may be a modulating envelope of a carrier wave (CW). The backscatter device 405 may respond by backscattering of the CW. The communication session may include multiple rounds, such as for purposes of contention resolution when multiple backscatter devices respond to a query. A channel between the RF source 410 and the backscatter device 405 of the backscatter link 415 may be associated with a first backscatter link channel response value (sometimes referred to as a first backscatter link channel coefficient or a first backscatter link gain value), hBD. As described below, the backscatter device 405 may have reflection-on periods and reflection-off periods that follow a pattern that is based at least in part on the transmission of information bits by the backscatter device 405. The reader 408 may detect the reflection pattern of the backscatter device 405 and obtain the backscatter communication information via the backscatter link 415. A channel between the reader 408 and the backscatter device 405 of the backscatter link 415 may be associated with a second backscatter link channel response value (sometimes referred to as a second backscatter link channel coefficient or a second backscatter link channel gain value), hDU. In addition, the RF source 410 and the reader 408 may communicate (for example, reference signals and/or data signals) via a direct link 420. A channel between the RF source 410 and the reader 408 of the direct link 420 may be associated with a direct link channel response value (sometimes referred to as a direct link channel coefficient or a direct link channel gain value), hBU.

Thus, the resulting signal received at the reader 408, which is the superposition of the signal received via the direct link 420 and the signal received via the backscatter link 415, may be denoted as y(n). This signal, y(n), is shown by reference number 435. As shown, when s(n)=0 (indicated by reference number 440 in the plot shown at reference number 430), the backscatter device 405 may switch off reflection, and thus the reader 408 receives only the direct link 420 signal. When s(n)=1 (indicated by reference number 445 in the plot shown at reference number 430), the backscatter device 405 may switch on reflection, and thus the reader 408 receives a superposition of both the direct link 420 signal and the backscatter link 415 signal. To receive the information bits transmitted by the backscatter device 405, the reader 408 may first decode x(n) based at least in part on the direct link channel response value of hBU(n) by treating the backscatter link 415 signal as interference, as shown by reference number 425. The reader 408 may then detect the existence of the signal component.

As indicated above, FIG. 4 is provided as an example. Other examples may differ from what is described with respect to FIG. 4.

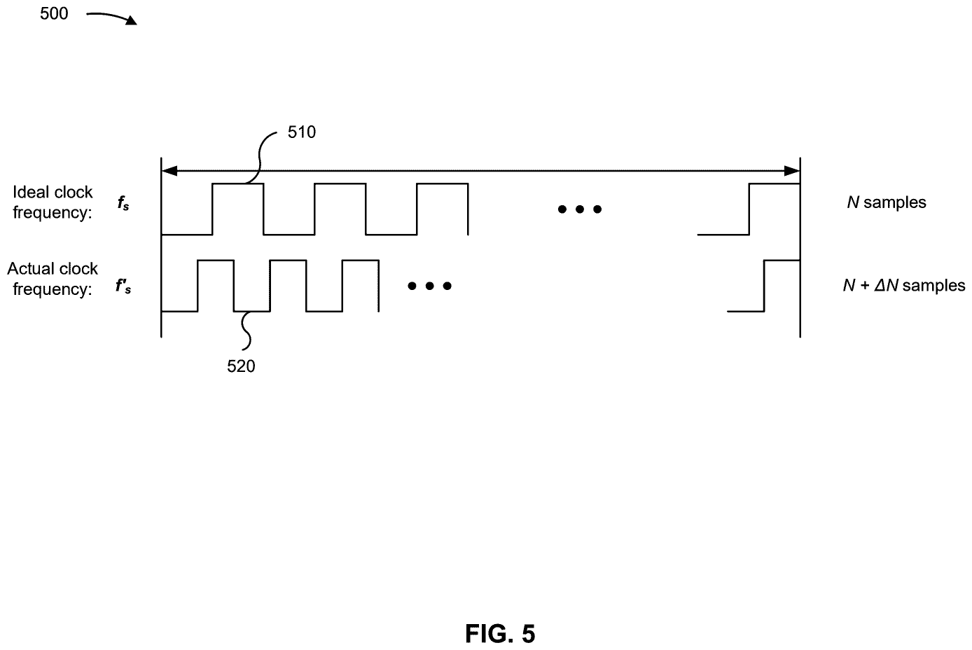

FIG. 5 is a diagram illustrating an example 500 of clock adjustment.

As shown by reference number 510, a reader-to-device (R2D) transmission may be associated with a time T, during which an ideal quantity of N samples are to occur when using an ideal clock frequency fₛ. To calibrate or otherwise adjust a clock, an A-IoT device may determine an actual quantity of samples N+ΔN, as shown by reference number 520, that occur during the time T according to the clock of the A-IoT device. In this case, the A-IoT device may estimate a device clock frequency

$${f}_{s}^{′} = ( \frac{N + Δ N}{N} ) \times {f}_{s} ,$$

where fₛ′ represents the device clock frequency. Based on information identifying a quantity of clock counts per D2R chip, X, the A-IoT device can determine an adjusted quantity of clock counts per D2R chip as

$${X}^{′} = ( \frac{N + Δ N}{N} ) \times X .$$

The A-IoT device can use the adjusted quantity of clock counts to perform sampling in accordance with the ideal clock frequency (e.g., without adjusting the clock frequency of the clock). Alternatively, the A-IoT can determine a clock frequency adjustment as a factor

$$( \frac{N}{N + Δ N} )$$

using digital clock oscillation. In some examples, synchronizing using sample counts, as described above, may achieve a clock frequency accuracy of between approximately 1% to 3% for some ultra-high frequency (UHF) RFID tags.

As indicated above, FIG. 5 is provided as an example. Other examples may differ from what is described with respect to FIG. 5.

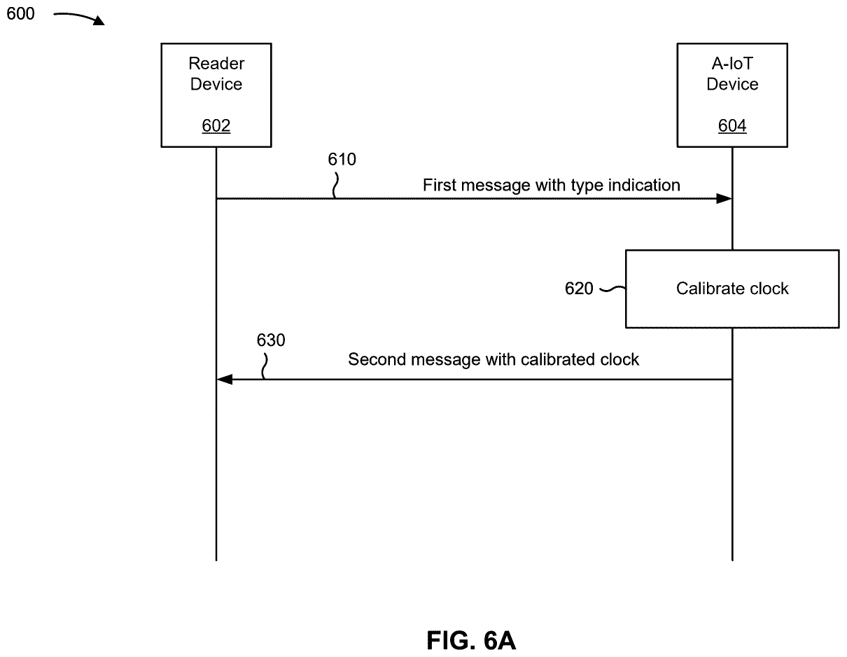

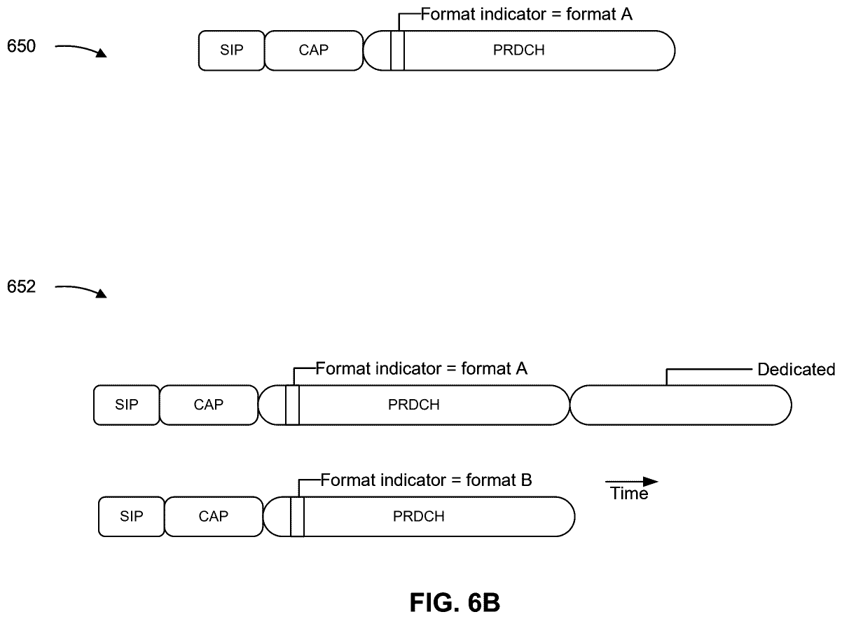

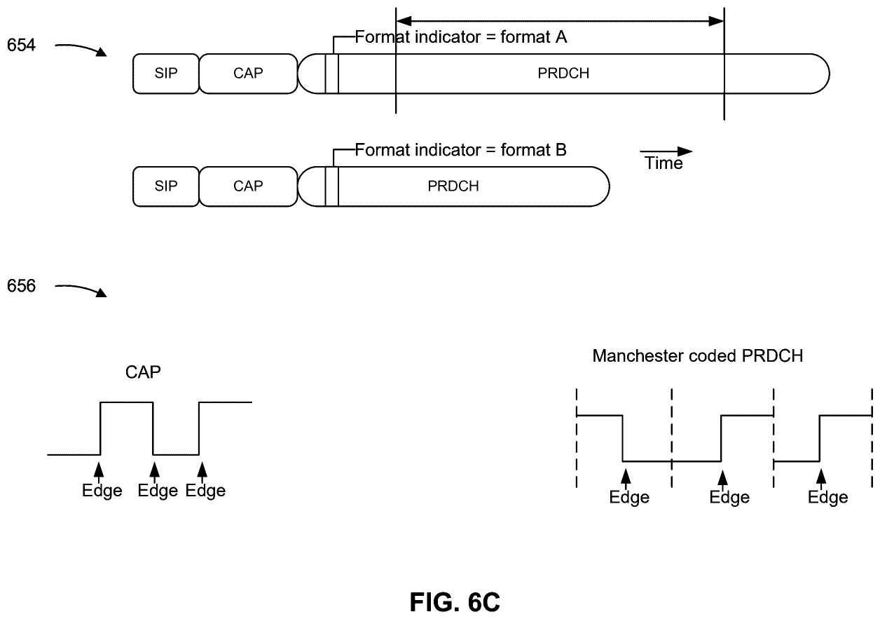

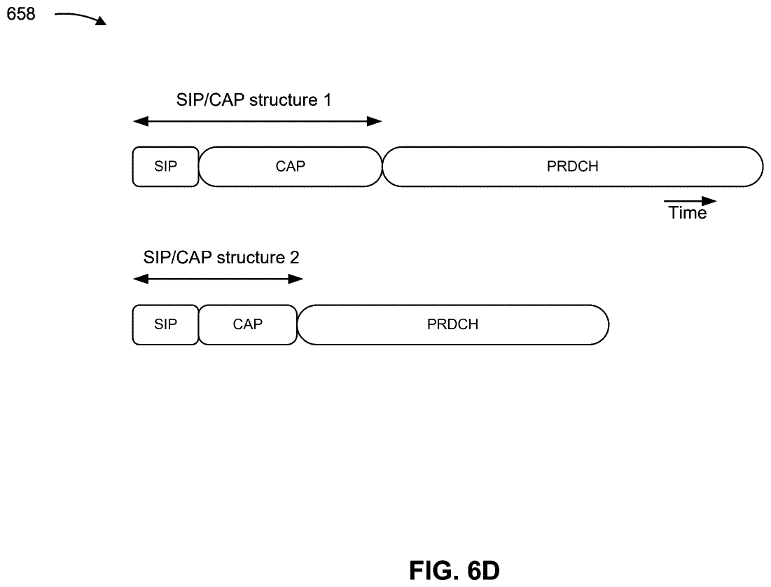

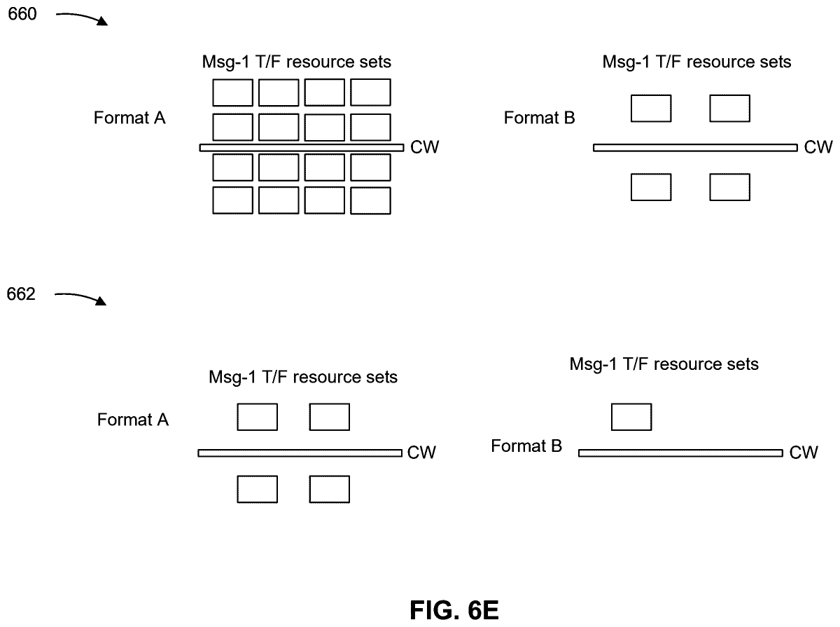

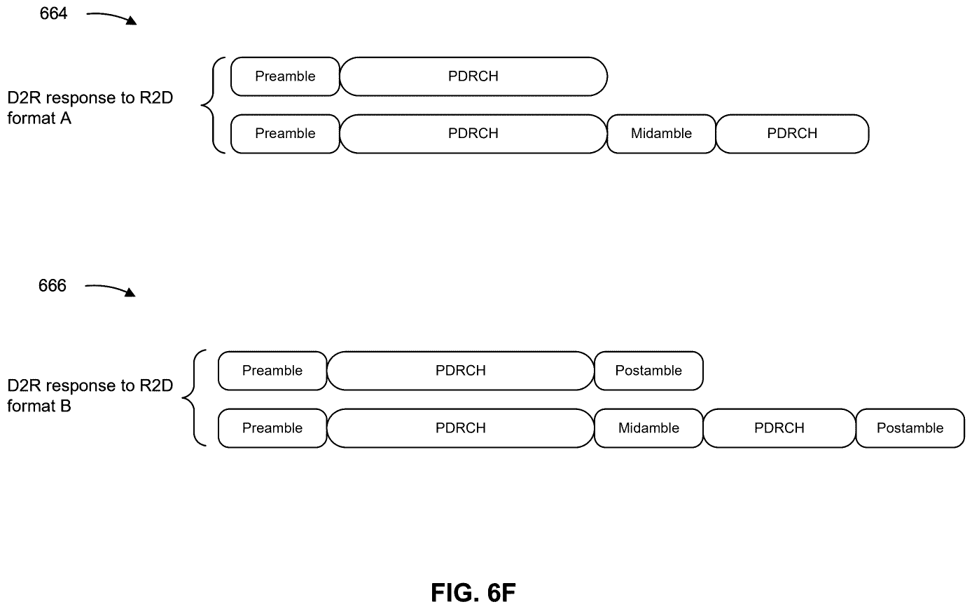

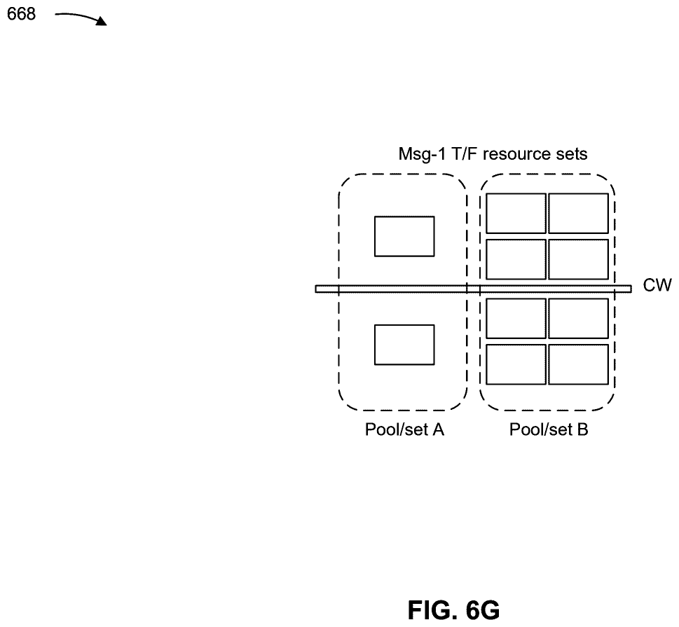

FIGS. 6A-6G are diagrams illustrating an example 600 associated with sampling frequency offset configuration. As shown in FIG. 6A, example 600 includes communication between a reader device 602 and an A-IoT device 604. In some aspects, the reader device 602 may correspond to a UE 120 or a network node 110. In some aspects, the A-IoT device 604 may correspond to the A-IoT device 180.

As further shown in FIG. 6A, and by reference number 610, the reader device 602 may transmit a first message with a type indication. For example, the reader device 602 may transmit, to the A-IoT device 604, an R2D message that includes a type indication of whether the first message is associated with a clock adjustment or other calibration. In some aspects, the A-IoT device 604 may determine whether to respond to the first message. For example, when the A-IoT device 604 receives a first message with a first format, such as a first message with a type indication indicating that the first message is for clock adjustment, and when the A-IoT device 604 is capable of performing clock adjustment to a configured degree of accuracy (e.g., 1%), the A-IoT device 604 may determine to perform clock adjustment and transmit a second message as a response. Alternatively, when the first message is associated with a clock adjustment, but the A-IoT device 604 is not capable of performing clock adjustment (or is capable of performing clock adjustment but not to the configured degree of accuracy), the A-IoT device 604 may forgo responding to the first message. Additionally, or alternatively, when the A-IoT device 604 receives a first message with a second format, such as a first message with a type indication indicating that the first message is not for clock adjustment, the A-IoT device 604 may generate the second message as a response without performing clock adjustment.

In some aspects, the first message is configured with a format that is selected for clock adjustment. For example, when clock adjustment is to be performed using the first message, the reader device 602 may transmit the first message with at least a configured time duration that is long enough to permit the A-IoT device 604 to perform clock adjustment to the configured degree of accuracy. Additionally, or alternatively, when clock adjustment is to be performed on the first message, the reader device 602 may transmit the first message with at least a configured bandwidth that is large enough to permit the A-IoT device 604 to identify rising or falling edges of an OOK symbol, as described in more detail herein.

In some aspects, the reader device 602 may include an explicit type indication in the first message. For example, as shown in FIG. 6B, and by example 650, the reader device 602 may transmit a first message that includes a start indicator part (SIP) section, a clock acquisition part (CAP) section, and a physical R2D channel (PRDCH) section. In this case, the read device 602 may set a bit (or multi-bit) indicator within the PRDCH section to indicate whether the first message is a first format (e.g., for clock adjustment) or a second format (e.g., not for clock adjustment). In some aspects, the bit (or multi-bit) indicator may be a 1-bit format indicator (e.g., a synchronization indicator, type indicator, clock indicator, adjustment indicator, or device selection indicator, among other examples). For example, the PRDCH section may convey a bit with a first value for a first format and a second value for a second format. Additionally, or alternatively, the bit (or multi-bit) indicator may be a device group or device type indicator. In this case, a first device group or device type may be capable of performing clock adjustment to a configured degree and a second device group or device type may not be capable of performing clock adjustment to the configured degree. Although some aspects are described herein in terms of two formats, in other aspects, other formats may be used, such as different formats for different degrees of clock adjustment accuracy.

In some aspects, the reader device 602 may include a time duration for clock adjustment in connection with an indication (e.g., explicit or implicit) of a type of the first message. For example, as shown in FIG. 6B, and by example 652, the reader device 602 may transmit a first message with a type indicator of the first format and may include a dedicated time domain portion for performing clock adjustment. In contrast, when the reader device 602 transmits the first message with a type indicator of the second format, the reader device 602 may omit the dedicated time domain portion for performing clock adjustment. In some aspects, the dedicated time domain portion may include a set of OOK patterns that the A-IoT device 604 is configured to use for clock adjustment. In some aspects, at least a portion of the dedicated time domain portion may be usable for another purpose (e.g., in addition to clock adjustment), such as for carrier frequency synchronization.

Additionally, or alternatively, the A-IoT device 604 may be configured to use a portion of a PRDCH duration for clock adjustment. For example, the reader device 602 may transmit the PRDCH with Manchester coding, in which each Manchester codeword uses two OOK symbols. In this case, each Manchester codeword includes a rising or falling edge within a middle (e.g., at an OOK symbol border). In this case, the A-IoT device 604 may use configured information identifying an OOK symbol length, which the A-IoT device 604 may identify using a CAP symbol, to determine a time duration for clock adjustment. As shown in FIG. 6C, and by example 654, the reader device 602 may transmit a PRDCH of at least a threshold length or may extend a length of a PRDCH section of a first message when the first format is indicated (e.g., for clock adjustment) relative to when the second format is indicated (e.g., not for clock adjustment). As further shown by example 656, the CAP section may include a set of edges (e.g., rising edges and falling edges), associated with a set of OOK symbols, from which the A-IoT device 604 can derive an OOK symbol length. Using the OOK symbol length and a set of rising edges or falling edges of a Manchester coded PRDCH section, the A-IoT device 604 can determine a clock offset and perform clock adjustment.

In some aspects, the reader device 602 may configure an implicit indication as the type indication within the first message. For example, the reader device 602 may configure a particular structure for the first message and the A-IoT device 604 may interpret whether the first message is the first format or the second format based on the particular structure. As an example, as shown in FIG. 6D, and by example 658, the reader device 602 may extend the SIP/CAP sections for the first message when the first message is for clock adjustment, relative to when the first message is not for clock adjustment. Alternatively, the reader device 602 may use a format of the SIP/CAP sections that has at least a threshold length for clock adjustment (and another format without the threshold length for non-clock-adjustment). In this case, the reader device 602 extends the CAP section, as shown, to provide the A-IoT device 604 with additional OOK symbols in the CAP section from which to derive a frequency offset for clock adjustment.

Additionally, or alternatively, the reader device 602 may implicitly indicate a format of the first message by configuring communication resources for a D2R response (e.g., the second message). For example, the reader device 602 may transmit an R2D message (e.g., the first message) to trigger random access for the A-IoT device 604. In this case, a set of time or frequency resources that the reader device 602 indicates for the random access for the A-IoT device 604 may be configured to provide an indication of whether the R2D message is to trigger clock adjustment. In other words, the reader device 602 may configure denser time or frequency resources for clock adjustment by A-IoT devices 604 capable of performing clock adjustment to a configured degree. In contrast, the reader device 602 may configure less dense time or frequency resources (e.g., a larger guard band or guard interval) for A-IoT devices 604 not capable of performing clock adjustment to the configured degree. As shown in FIG. 6E, and by example 660, the reader device 602 may transmit a first message scheduling a set of 16 resources within a particular time interval and frequency band, which may correspond to the first message being a first format (e.g., for clock adjustment capable A-IoT devices 604). In contrast, the reader device 602 may transmit a first message scheduling a set of 4 resources within the same time interval and frequency band, which may correspond to the first message being a second format (e.g., for A-IoT devices 604 not capable of or triggered to perform clock adjustment to a configured degree). In another example 662, the reader device 602 may transmit a first message scheduling multi-resource random access (e.g., 4 resources for random access) in a particular time interval and frequency band, which may correspond to the first message being the first format. In contrast, the reader device 602 may transmit a first message scheduling single resource random access (e.g., 1 resource for random access), which may correspond to the first message being the second format.

In some aspects, the reader device 602 may transmit a first message that is capable of having a single format. For example, rather than having a type indication to indicate a first format (e.g., for clock adjustment) and a second format (e.g., not for clock adjustment), the reader device 602 may be configured to transmit the first message with a type indication that is for clock adjustment. In this case, when the A-IoT device 604 is configured to calibrate a sampling clock to a configured degree of accuracy, the A-IoT device 604 transmits a second message as a response, using a first resource configuration (e.g., a first resource pool or resource set). In contrast, when the A-IoT device 604 is not configured to calibrate a sampling clock to a configured degree of accuracy, the A-IoT device 604 transmits a second message as a response using a second resource configuration (e.g., a second resource pool or resource set). For example, as shown in FIG. 6G, and by example, 668, the reader device 602 transmits a first message (e.g., an R2D message triggering random access) and configures a first resource pool with 2 resources for random access and a second resource pool with 8 resources for random access. In this case, the denser (second) resource pool is allocated for A-IoT devices 604 with a clock adjustment that achieves (or is configured to achieve) the configured degree of accuracy, and the less dense (first) resource pool is allocated for A-IoT devices 604 with a clock adjustment that does not achieve (or is not configured to achieve) the configured degree of accuracy.

In some aspects, the A-IoT device 604 is statically configured with respect to whether to select the first resource configuration or the second resource configuration. In this case, the A-IoT device 604 selects the first resource configuration or the second resource configuration based on a device capability (e.g., whether the A-IoT device 604 is configured with a capability of calibrating a sampling clock to a configured degree of accuracy. In some aspects, the A-IoT device is dynamically configured with respect to whether to select the first resource configuration or the second resource configuration. In this case, the A-IoT device 604 estimates or measures a sampling clock accuracy (e.g., after performing clock adjustment) and, based on whether the sampling clock accuracy achieves the configured degree of accuracy, the A-IoT device 604 may select the first resource configuration or the second resource configuration.

As further shown in FIG. 6A, and by reference number 620, the A-IoT device 604 may calibrate a clock. For example, the A-IoT device 604 may perform a clock adjustment procedure using the first message and based on the type indication. In this case, the A-IoT device 604 may perform a clock adjustment procedure, such as by detecting symbols (e.g., leading or trailing edges of OOK symbols) to derive a timing, as described above.

As further shown in FIG. 6A, and by reference number 630, the A-IoT device 604 may transmit a second message. For example, the A-IoT device 604 may transmit, to the reader device 602, a D2R message. In some aspects, the A-IoT device 604 may generate a D2R waveform. For example, the A-IoT device 604 may generate the D2R waveform and the reader device 602 may upconvert the D2R waveform to a transmission that is transmitted to the reader device 602 (e.g., via backscattering). In some aspects, the A-IoT device 604 may transmit the second message with a calibrated clock. For example, based on performing clock adjustment triggered by the first message, the A-IoT device 604 may transmit the second message using the calibrated clock. In contrast, when the first message is not associated with triggering clock adjustment, the A-IoT device 604 may transmit the second message without performing clock adjustment. In some aspects, the A-IoT device 604 may forgo transmitting the second message. For example, when the first message is in a format associated with performing clock adjustment to a configured degree of accuracy, the A-IoT device 604 may forgo transmitting the second message when the A-IoT device 604 cannot perform clock adjustment (or can perform clock adjustment but not to the configured degree of accuracy).

In some aspects, the A-IoT device 604 may transmit the second message using a particular message format that may be based on a clock inaccuracy (e.g., a level of clock inaccuracy) or a format of the first message (e.g., whether the first message is a first format or a second format). For example, when the A-IoT device 604 is associated with a relatively large clock inaccuracy (e.g., as a result of not performing clock adjustment or performing clock adjustment to a low degree of accuracy), the A-IoT device 604 may transmit the second message with a set of reference signals or ambles (e.g., a D2R preamble, midamble, or postamble). In this case, a presence of the set of reference signals or ambles may permit the reader device 602 to estimate and compensate for clock inaccuracy at the A-IoT device 604. In contrast, when the A-IoT device 604 is associated with a relatively small clock inaccuracy (e.g., as a result of performing clock adjustment to a configured high degree of accuracy), the A-IoT device 604 may omit a set of reference signals or ambles from the second message, thereby improving spectral efficiency. As an example, as shown in FIG. 6F, and by example 664, when the D2R message is a response to a first format of R2D message (e.g., a first message with a type indication for clock adjustment), the D2R message may include a first format with a preamble and a physical D2R channel (PDRCH) or a second format with a preamble, a first PDRCH, a midamble, and a second PDRCH. In contrast, as shown by example 666, when the D2R message is a response to a second format of R2D message (e.g., a message with a type indication of not being for clock adjustment), the D2R message may include a first format with a preamble, a PDRCH, and a postamble or a second format with a preamble, a first PDRCH, a midamble, a second PDRCH, and a postamble. In other words, when the A-IoT device 604 is triggered to perform clock adjustment, the A-IoT device 604 may, for example, forgo including a postamble in a second message, thereby improving spectral efficiency. Further when the A-IoT device 604 is triggered to perform clock adjustment, the A-IoT device 604 may, for example, use a shorter preamble, thereby improving spectral efficiency. For example, when a D2R message is a response to a first format of R2D message, the D2R message may be a first format with a first length preamble and when the D2R message is a response to a second format of R2D message, the D2R message may be a second format with a second length preamble.

As indicated above, FIGS. 6A-6G are provided as an example. Other examples may differ from what is described with respect to FIGS. 6A-6G.

FIG. 7 is a diagram illustrating an example process 700 performed, for example, at an A-IoT device or an apparatus of an A-IoT device. Example process 700 is an example where the apparatus or the A-IoT device (e.g., A-IoT device 180) performs operations associated with sampling frequency offset configuration.

As shown in FIG. 7, in some aspects, process 700 may include receiving a first message, wherein the first message includes a type indication associated with whether the first message is associated with a clock adjustment (block 710). For example, the A-IoT device (e.g., using reception component 902 and/or communication manager 906, depicted in FIG. 9) may receive a first message, wherein the first message includes a type indication associated with whether the first message is associated with a clock adjustment, as described above.

As further shown in FIG. 7, in some aspects, process 700 may include selectively transmitting, to the reader device, a second message based on whether the first message is associated with the clock adjustment (block 720). For example, the A-IoT device (e.g., using transmission component 904 and/or communication manager 906, depicted in FIG. 9) may selectively transmit, to the reader device, a second message based on whether the first message is associated with the clock adjustment, as described above. In some aspects, when selectively transmitting, the A-IoT device may transmit the second message. For example, the A-IoT device may transmit the second message when the first message is for clock adjustment and the A-IoT device is capable of clock adjustment. Additionally, or alternatively, the A-IoT device may transmit the second message when the first message is not for clock adjustment. In contrast, when the first message is for clock adjustment and the A-IoT device is not capable of clock adjustment (or is capable of clock adjustment but not to a configured accuracy level), the A-IoT device may forgo transmission. In some aspects, transmission may include generation of a message (e.g., which the reader device may cause to be transmitted via backscattering).

Process 700 may include additional aspects, such as any single aspect or any combination of aspects described below and/or in connection with one or more other processes described elsewhere herein.

In a first aspect, selectively transmitting the second message comprises selectively transmitting the second message based on whether a device capability is associated with the clock adjustment.

In a second aspect, alone or in combination with the first aspect, the type indication associated with whether the first message is associated with the clock adjustment includes an explicit format indicator.

In a third aspect, alone or in combination with one or more of the first and second aspects, the first message is associated with a time duration usable for the clock adjustment.

In a fourth aspect, alone or in combination with one or more of the first through third aspects, the time duration is a dedicated time duration.

In a fifth aspect, alone or in combination with one or more of the first through fourth aspects, the time duration is a portion of a reader-to-device channel duration within the first message, and a set of symbol edges are used for the clock adjustment.

In a sixth aspect, alone or in combination with one or more of the first through fifth aspects, the type indication associated with whether the first message is associated with the clock adjustment is based on a message structure of the first message.

In a seventh aspect, alone or in combination with one or more of the first through sixth aspects, the type indication associated with whether the first message is associated with the clock adjustment is based on a resource configuration indicated for the second message.

In an eighth aspect, alone or in combination with one or more of the first through seventh aspects, a format of the second message is based on at least one of a clock accuracy parameter or whether the first message is associated with the clock adjustment.

In a ninth aspect, alone or in combination with one or more of the first through eighth aspects, the format of the second message includes at least one of a reference signal format or an amble format.

In a tenth aspect, alone or in combination with one or more of the first through ninth aspects, selectively transmitting the second message comprises transmitting the second message using a first resource configuration or a second resource configuration, wherein whether the first resource configuration or the second resource configuration is selected is based on a device capability relating to the clock adjustment.

In an eleventh aspect, alone or in combination with one or more of the first through tenth aspects, a selection of the first resource configuration or the second resource configuration is a static selection associated with the device capability.

In a twelfth aspect, alone or in combination with one or more of the first through eleventh aspects, a selection of the first resource configuration or the second resource configuration is a dynamic selection associated with a result of performing clock adjustment.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a reader device or an apparatus of a reader device. Example process 800 is an example where the apparatus or the reader device (e.g., a UE 120) performs operations associated with sampling frequency offset configuration.

As shown in FIG. 8, in some aspects, process 800 may include transmitting a first message, wherein the first message includes a type indication associated with whether the first message is associated with a clock adjustment (block 810). For example, the reader device (e.g., using transmission component 1004 and/or communication manager 1006, depicted in FIG. 10) may transmit a first message, wherein the first message includes a type indication associated with whether the first message is associated with a clock adjustment, as described above.

As further shown in FIG. 8, in some aspects, process 800 may include selectively receiving, from the A-IoT device, a second message based on whether the first message is associated with the clock adjustment (block 820). For example, the reader device (e.g., using reception component 1002 and/or communication manager 1006, depicted in FIG. 10) may selectively receive, from the A-IoT device, a second message based on whether the first message is associated with the clock adjustment, as described above.

Process 800 may include additional aspects, such as any single aspect or any combination of aspects described below and/or in connection with one or more other processes described elsewhere herein.

In a first aspect, selectively receiving the second message comprises selectively receiving the second message based on whether a device capability is associated with the clock adjustment.

In a second aspect, alone or in combination with the first aspect, the type indication associated with whether the first message is associated with the clock adjustment includes an explicit format indicator.

In a third aspect, alone or in combination with one or more of the first and second aspects, the first message is associated with a time duration usable for the clock adjustment.

In a fourth aspect, alone or in combination with one or more of the first through third aspects, the time duration is a dedicated time duration.

In a fifth aspect, alone or in combination with one or more of the first through fourth aspects, the time duration is a portion of a reader-to-device channel duration within the first message, and a set of symbol edges are used for the clock adjustment.

In a sixth aspect, alone or in combination with one or more of the first through fifth aspects, the type indication associated with whether the first message is associated with the clock adjustment is based on a message structure of the first message.

In a seventh aspect, alone or in combination with one or more of the first through sixth aspects, the type indication associated with whether the first message is associated with the clock adjustment is based on a resource configuration indicated for the second message.

In an eighth aspect, alone or in combination with one or more of the first through seventh aspects, a format of the second message is based on at least one of a clock accuracy parameter or whether the first message is associated with the clock adjustment.

In a ninth aspect, alone or in combination with one or more of the first through eighth aspects, the format of the second message includes at least one of a reference signal format or an amble format.

In a tenth aspect, alone or in combination with one or more of the first through ninth aspects, selectively receiving the second message comprises receiving the second message using a first resource configuration or a second resource configuration, wherein whether the first resource configuration or the second resource configuration is selected is based on a device capability relating to the clock adjustment.

In an eleventh aspect, alone or in combination with one or more of the first through tenth aspects, a selection of the first resource configuration or the second resource configuration is a static selection associated with the device capability.

In a twelfth aspect, alone or in combination with one or more of the first through eleventh aspects, a selection of the first resource configuration or the second resource configuration is a dynamic selection associated with a result of performing clock adjustment.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be an A-IoT device, or an A-IoT device may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 190 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 185 described in connection with FIG. 1) of the A-IoT device.

In some aspects, the apparatus 900 may be configured to perform one or more operations described herein in connection with FIGS. 6A-6G. Additionally, or alternatively, the apparatus 900 may be configured to perform one or more processes described herein, such as process 700 of FIG. 7. In some aspects, the apparatus 900 and/or one or more components shown in FIG. 9 may include one or more components of the A-IoT device described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the A-IoT device described above in connection with FIG. 1, such as a radio, one or more RF chains, one or more transceivers, or one or more modems, each of which may in turn be coupled with one or more antennas of the A-IoT device.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the A-IoT device described above in connection with FIG. 1, such as a radio, one or more RF chains, one or more transceivers, or one or more modems, each of which may in turn be coupled with one or more antennas of the A-IoT device described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a reader device, a first message, wherein the first message includes a type indication associated with whether the first message is associated with a clock adjustment. The transmission component 904 may selectively transmit, to the reader device, a second message based on whether the first message is associated with the clock adjustment.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a reader device, or a reader device may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the reader device.

In some aspects, the apparatus 1000 may be configured to perform one or more operations described herein in connection with FIGS. 6A-6G. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the reader device described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the reader device described above in connection with FIG. 1, such as a radio, one or more RF chains, one or more transceivers, or one or more modems, each of which may in turn be coupled with one or more antennas of the reader device.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the reader device described above in connection with FIG. 1, such as a radio, one or more RF chains, one or more transceivers, or one or more modems, each of which may in turn be coupled with one or more antennas of the reader device described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to an A-IoT device, a first message, wherein the first message includes a type indication associated with whether the first message is associated with a clock adjustment. The reception component 1002 may selectively receive, from the A-IoT device, a second message based on whether the first message is associated with the clock adjustment.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by an ambient Internet-of-Things (A-IoT) device, comprising: receiving, from a reader device, a first message, wherein the first message includes a type indication associated with whether the first message is associated with a clock adjustment; and selectively transmitting, to the reader device, a second message based on whether the first message is associated with the clock adjustment.

Aspect 2: The method of Aspect 1, wherein selectively transmitting the second message comprises: selectively transmitting the second message based on whether a device capability is associated with the clock adjustment.

Aspect 3: The method of any of Aspects 1-2, wherein the type indication associated with whether the first message is associated with the clock adjustment includes an explicit format indicator.

Aspect 4: The method of any of Aspects 1-3, wherein the first message is associated with a time duration usable for the clock adjustment.

Aspect 5: The method of Aspect 4, wherein the time duration is a dedicated time duration.

Aspect 6: The method of Aspect 4, wherein the time duration is a portion of a reader-to-device channel duration within the first message, and wherein a set of symbol edges are used for the clock adjustment.

Aspect 7: The method of any of Aspects 1-6, wherein the type indication associated with whether the first message is associated with the clock adjustment is based on a message structure of the first message.

Aspect 8: The method of any of Aspects 1-7, wherein the type indication associated with whether the first message is associated with the clock adjustment is based on a resource configuration indicated for the second message.

Aspect 9: The method of any of Aspects 1-8, wherein a format of the second message is based on at least one of: a clock accuracy parameter or whether the first message is associated with the clock adjustment.

Aspect 10: The method of Aspect 9, wherein the format of the second message includes at least one of: a reference signal format or an amble format.

Aspect 11: The method of any of Aspects 1-10, wherein selectively transmitting the second message comprises: transmitting the second message using a first resource configuration or a second resource configuration, wherein whether the first resource configuration or the second resource configuration is selected is based on a device capability relating to the clock adjustment.

Aspect 12: The method of Aspect 11, wherein a selection of the first resource configuration or the second resource configuration is a static selection associated with the device capability.

Aspect 13: The method of Aspect 11, wherein a selection of the first resource configuration or the second resource configuration is a dynamic selection associated with a result of performing clock adjustment.

Aspect 14: A method of wireless communication performed by a reader device, comprising: transmitting, to an ambient Internet-of-Things (A-IoT) device, a first message, wherein the first message includes a type indication associated with whether the first message is associated with a clock adjustment; and selectively receiving, from the A-IoT device, a second message based on whether the first message is associated with the clock adjustment.

Aspect 15: The method of Aspect 14, wherein selectively receiving the second message comprises: selectively receiving the second message based on whether a device capability is associated with the clock adjustment.

Aspect 16: The method of any of Aspects 14-15, wherein the type indication associated with whether the first message is associated with the clock adjustment includes an explicit format indicator.

Aspect 17: The method of any of Aspects 14-16, wherein the first message is associated with a time duration usable for the clock adjustment.

Aspect 18: The method of Aspect 17, wherein the time duration is a dedicated time duration.

Aspect 19: The method of Aspect 17, wherein the time duration is a portion of a reader-to-device channel duration within the first message, and wherein a set of symbol edges are used for the clock adjustment.

Aspect 20: The method of any of Aspects 14-19, wherein the type indication associated with whether the first message is associated with the clock adjustment is based on a message structure of the first message.

Aspect 21: The method of any of Aspects 14-20, wherein the type indication associated with whether the first message is associated with the clock adjustment is based on a resource configuration indicated for the second message.

Aspect 22: The method of any of Aspects 14-21, wherein a format of the second message is based on at least one of: a clock accuracy parameter or whether the first message is associated with the clock adjustment.

Aspect 23: The method of Aspect 22, wherein the format of the second message includes at least one of: a reference signal format or an amble format.

Aspect 24: The method of any of Aspects 14-23, wherein selectively receiving the second message comprises: receiving the second message using a first resource configuration or a second resource configuration, wherein whether the first resource configuration or the second resource configuration is selected is based on a device capability relating to the clock adjustment.

Aspect 25: The method of Aspect 24, wherein a selection of the first resource configuration or the second resource configuration is a static selection associated with the device capability.

Aspect 26: The method of Aspect 24, wherein a selection of the first resource configuration or the second resource configuration is a dynamic selection associated with a result of performing clock adjustment.

Aspect 27: An apparatus for wireless communication at a device, the apparatus comprising one or more processors: one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An ambient Internet-of-Things (A-IoT) device for wireless communication, comprising:
one or more memories; and
one or more processors, coupled to the one or more memories, configured to cause the A-IoT device to:
receive, from a reader device, a first message, wherein the first message includes a type indication associated with whether the first message is associated with a clock adjustment; and
selectively transmit, to the reader device, a second message based on whether the first message is associated with the clock adjustment.

2. The A-IoT device of claim 1, wherein the one or more processors, to cause the A-IoT device to selectively transmit the second message, are configured to cause the A-IoT device to:
selectively transmit the second message based on whether a device capability is associated with the clock adjustment.

3. The A-IoT device of claim 1, wherein the type indication associated with whether the first message is associated with the clock adjustment includes a format indicator.

4. The A-IoT device of claim 1, wherein the first message is associated with a time duration usable for the clock adjustment.

5. The A-IoT device of claim 4, wherein the time duration is a dedicated time duration.

6. The A-IoT device of claim 4, wherein the time duration is a portion of a reader-to-device channel duration within the first message, and
wherein a set of symbols are used for the clock adjustment.

7. The A-IoT device of claim 1, wherein the type indication associated with whether the first message is associated with the clock adjustment is based on a message structure of the first message.

8. The A-IoT device of claim 1, wherein the type indication associated with whether the first message is associated with the clock adjustment is based on a resource configuration indicated for the second message.

9. The A-IoT device of claim 1, wherein a format of the second message is based on at least one of: a clock accuracy parameter or whether the first message is associated with the clock adjustment.

10. The A-IoT device of claim 9, wherein the format of the second message includes at least one of: a reference signal format or an amble format.

11. The A-IoT device of claim 1, wherein the one or more processors, to cause the A-IoT device to selectively transmit the second message, are configured to cause the A-IoT device to:
transmit the second message using a first resource configuration or a second resource configuration, wherein whether the first resource configuration or the second resource configuration is selected is based on a device capability relating to the clock adjustment.

12. The A-IoT device of claim 11, wherein a selection of the first resource configuration or the second resource configuration is a static selection associated with the device capability.

13. The A-IoT device of claim 11, wherein a selection of the first resource configuration or the second resource configuration is a dynamic selection associated with a result of performing clock adjustment.

14. A reader device for wireless communication, comprising:
one or more memories; and
one or more processors, coupled to the one or more memories, configured to cause the reader device to:
transmit, to an ambient Internet-of-Things (A-IoT) device, a first message, wherein the first message includes a type indication associated with whether the first message is associated with a clock adjustment; and
selectively receive, from the A-IoT device, a second message based on whether the first message is associated with the clock adjustment.

15. The reader device of claim 14, wherein the one or more processors, to cause the reader device to selectively receive the second message, are configured to cause the reader device to:
selectively receive the second message based on whether a device capability is associated with the clock adjustment.

16. The reader device of claim 14, wherein the type indication associated with whether the first message is associated with the clock adjustment includes an explicit format indicator.

17. The reader device of claim 14, wherein the first message is associated with a time duration usable for the clock adjustment.

18. The reader device of claim 17, wherein the time duration is a dedicated time duration.

19. The reader device of claim 17, wherein the time duration is a portion of a reader-to-device channel duration within the first message, and
wherein a set of symbol edges are used for the clock adjustment.

20. A method of wireless communication performed by an ambient Internet-of-Things (A-IoT) device, comprising:
receiving, from a reader device, a first message, wherein the first message includes a type indication associated with whether the first message is associated with a clock adjustment; and
selectively transmitting, to the reader device, a second message based on whether the first message is associated with the clock adjustment.
